(19) United States
(12) Patent Application Publication
(10) Pub. No.: US 2024/0245142 A1
(43) Pub. Date: Jul. 25, 2024

(54) AEROSOL GENERATION SYSTEM

(71) Applicant: Japan Tobacco Inc., Tokyo (JP)

(72) Inventors: Yasunobu INOUE, Tokyo (JP); Ryoji FUJITA, Tokyo (JP); Sumie MIKAMI, Tokyo (JP); Kazutoshi SERITA, Tokyo (JP)

(73) Assignee: Japan Tobacco Inc., Tokyo (JP)

(21) Appl. No.: 18/628,823

(22) Filed: Apr. 8, 2024

Related U.S. Application Data
(63) Continuation of application No. PCT/JP2021/045026, filed on Dec. 8, 2021.

(51) Int. Cl. A24F 40/65; A24F 40/20; A24F 40/51

(52) U.S. Cl. CPC A24F 40/65; A24F 40/20; A24F 40/51

(57) ABSTRACT

An aerosol generation system including a resistance heating unit that has a porous structure in at least a part thereof, and that heats an aerosol-generating base material from the inside, and a pair of plate-shaped conductive units provided on mutually opposed surfaces of the resistance heating unit.

### CROSS-REFERENCES TO RELATED APPLICATION

This application is a Continuation of PCT International Application No. PCT/JP2021/045026, filed on Dec. 8, 2021, which is hereby expressly incorporated by reference into the present application.

### TECHNICAL FIELD

The present invention relates to aerosol generation systems.

### BACKGROUND ART

Inhaler devices including electronic cigarettes and nebulizers that generate material to be inhaled by users are becoming widely popular. Such an inhaler device uses an aerosol source for generating an aerosol and a flavor source for imparting a flavor component to the generated aerosol, so as to be capable of generating a flavor-component-imparted aerosol. A user can taste the flavor by inhaling the flavor-component-imparted aerosol generated by the inhaler device.

In recent years, technology related to an inhaler device of a type that uses a stick-shaped substrate as an aerosol source or a flavor source is being actively developed. For example, Patent Literature 1 indicated below discloses a blade-shaped heater that is inserted into the stick-shaped substrate to heat the substrate from the inside thereof.

### CITATION LIST

### Patent Literature

Patent Literature 1: CN 209807157 U

### SUMMARY OF INVENTION

### Technical Problem

However, with regard to the heater disclosed in Patent Literature 1 indicated above, since the rate of temperature increase is not sufficiently high, it takes too much time for heating the substrate. This makes it difficult to offer a pleasant inhalation experience to the user using the inhaler device.

The present invention has been made in view of the above problem, and an object of the present invention is to provide a new and improved aerosol generation system that can further enhance the rate of temperature increase of the heater.

### Solution to Problem

In order to solve the above problem, an aspect of the present invention provides an aerosol generation system including: a resistive heat generator at least partially having a porous structure and heating an aerosol generating substrate from an inside thereof; and a pair of tabular electric conductors provided at opposite surfaces of the resistive heat generator.

The porous structure may include a plurality of regions with different porosities from each other.

The resistive heat generator may contain barium titanate.

The resistive heat generator may further contain less than 0.3 g/cm³ of carbon.

A securing section having an insertion section into which the electric conductors are inserted may further be included. The securing section secures the electric conductors to a housing.

The securing section may be composed of a super engineering plastic material.

The securing section may have a circular or rectangular tabular shape.

Each of the electric conductors may be composed of metal or carbon.

Each of the electric conductors may be composed of a nickel-containing iron alloy.

The resistive heat generator may have a tabular shape.

A thickness of the tabular shape may be smaller than ¼ of a width of the tabular shape.

The aerosol generating substrate into which the resistive heat generator and the electric conductors are inserted may further be included.

At least one of the electric conductors may include a rib formed by bending an edge of the electric conductor along an outer shape of the resistive heat generator from the opposite surfaces of the resistive heat generator.

The resistive heat generator may have an angularly protruding shape toward a leading end to be inserted into the aerosol generating substrate.

At least one of the electric conductors may further include a leading-end rib formed by bending an edge of the electric conductor along the shape at the leading end of the resistive heat generator.

The resistive heat generator and the electric conductors may be adhered together by using a conductive adhesive paste.

The resistive heat generator may be a PTC heater.

A temperature of heat generated by the resistive heat generator may be below 350° C.

### Advantageous Effects of Invention

According to the present invention described above, the aerosol generation system can further enhance the rate of temperature increase of the heater.

### BRIEF DESCRIPTION OF DRAWINGS

FIG. 1 is a schematic diagram schematically illustrating a configuration example of an inhaler device.

FIG. 2 is a perspective view of a heater according to an embodiment of the present invention.

FIG. 3 is an exploded perspective view of a heater body included in the heater illustrated in FIG. 2.

FIG. 4 is a graph schematically illustrating the relationship between the density of a carbon porous body and the electrical resistance value.

FIG. 5 is an exploded perspective view of a heater body according to a first modification.

FIG. 6 is an exploded perspective view of a heater body according to a second modification.

FIG. 7 is an exploded perspective view of a heater body according to a third modification.

### DESCRIPTION OF EMBODIMENTS

A preferred embodiment of the present invention will be described in detail below with reference to the appended drawings. In this description and the drawings, structural elements having substantially identical functional configurations will be given the same reference signs, and redundant descriptions thereof will be omitted.

### 1. Configuration Example of Inhaler Device

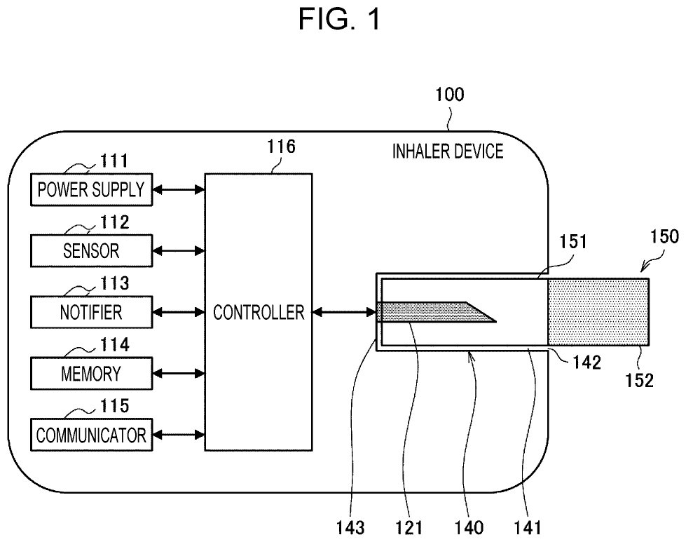

An inhaler device according to a present configuration example generates an aerosol by heating a substrate containing an aerosol source from inside the substrate. A present configuration example will be described below with reference to FIG. 1.

FIG. 1 is a schematic diagram schematically illustrating the configuration example of the inhaler device. As illustrated in FIG. 1, an inhaler device 100 according to this configuration example includes a power supply 111, a sensor 112, a notifier 113, a memory 114, a communicator 115, a controller 116, a heater 121, and a container 140. With regard to the inhaler device 100, inhalation is performed by a user in a state where a stick substrate 150 is accommodated in the container 140. The structural elements will be sequentially described below.

The inhaler device 100 and the stick substrate 150 operate in cooperation with each other to generate the aerosol to be inhaled by the user. Therefore, the combination of the inhaler device 100 and the stick substrate 150 may be regarded as an aerosol generation system.

The power supply 111 stores electric power. The power supply 111 supplies the electric power to the structural elements of the inhaler device 100. For example, the power supply 111 may be a rechargeable battery, such as a lithium ion secondary battery. The power supply 111 may be recharged by being connected to an external power supply by, for example, a USB (universal serial bus) cable. Alternatively, the power supply 111 may be recharged in a non-connected state with a power-transmitting device by wireless power transmission technology. As another alternative, the power supply 111 may be removable from the inhaler device 100 so as to be replaceable with a new power supply 111.

The sensor 112 detects various types of information regarding the inhaler device 100, and outputs the detected information to the controller 116. In an example, the sensor 112 may be a pressure sensor such as a microphone condenser, a flow sensor, or a temperature sensor. When detecting a numerical value generated in accordance with the user's inhalation, the pressure sensor, the flow sensor, or the temperature sensor can output information indicating that the inhalation has been performed by the user to the controller 116. In another example, the sensor 112 may be an input device, such as a button or a switch, receiving information input by the user. In particular, the sensor 112 may include a command button for starting/stopping aerosol generation. The input device that receives information input by the user can output the information input by the user to the controller 116. In another example, the sensor 112 may be a temperature sensor that detects the temperature of the heater 121. For example, by detecting the temperature of the heater 121 based on an electrical resistance value of the heater 121, the temperature sensor can determine the temperature of the stick substrate 150 accommodated in the container 140.

The notifier 113 notifies the user of information. In an example, the notifier 113 is a light-emitting device, such as an LED (light-emitting diode). Accordingly, when the power supply 111 needs to be recharged, when the power supply 111 is being recharged, or when an abnormality has occurred in the inhaler device 100, the notifier 113 can emit light in different patterns of light, respectively. Each pattern of light is a concept involving colors and on/off timings. Together with or in place of the light-emitting device, the notifier 113 may be, for example, a display device that displays an image, a sound output device that outputs sound, and a vibration device that vibrates. The notifier 113 may also provide notification information indicating that inhalation by the user is possible. The notification information indicating that inhalation by the user is possible may be provided when the temperature of the stick substrate 150 heated by the heater 121 reaches a predetermined temperature.

The memory 114 stores various types of information for operation of the inhaler device 100. The memory 114 is, for example, a non-volatile storage medium, such as a flash memory. An example of the information stored in the memory 114 is information regarding the OS (operating system) of the inhaler device 100, such as the control information about the various types of structural elements controlled by the controller 116. Another example of the information stored in the memory 114 is information regarding inhalation by the user, such as the number of times of inhalation, the inhalation time, and the accumulated inhalation time period.

The communicator 115 is a communication interface for exchanging information between the inhaler device 100 and another device. The communicator 115 performs communication in conformity with any wired or wireless communication standard. Such a communication standard may be, for example, a wireless LAN (local area network), a wired LAN, Wi-Fi (registered trademark), or Bluetooth (registered trademark). In an example, the communicator 115 may transmit the information regarding the inhalation by the user to a smartphone to cause the smartphone to display the information regarding the inhalation by the user. In another example, the communicator 115 may receive information about a new OS from a server to update the information about the OS stored in the memory 114.

The controller 116 functions as an arithmetic processing unit and a control device, and controls the overall operation in the inhaler device 100 in accordance with various programs. For example, the controller 116 is implemented by an electronic circuit, such as a CPU (central processing unit) or a microprocessor. Furthermore, the controller 116 may include a ROM (read only memory) that stores a program and arithmetic parameter to be used, and a RAM (random access memory) that temporarily stores an appropriately changing parameter. The inhaler device 100 executes various processes based on control by the controller 116. Examples of the processes controlled by the controller 116 include supplying of electric power from the power supply 111 to the other structural elements, recharging of the power supply 111, detection of information by the sensor 112, notification of information by the notifier 113, storing and reading of information by the memory 114, and exchanging of information by the communicator 115. Other processes executed by the inhaler device 100, such as an input of information to each structural element and a process based on information output from each structural element, are also controlled by the controller 116.

The container 140 has an internal space 141 and holds the stick substrate 150 while accommodating a portion of the stick substrate 150 within the internal space 141. The container 140 has an opening 142 through which the internal space 141 communicates with the outside, and holds the stick substrate 150 inserted in the internal space 141 through the opening 142. For example, the container 140 is a tubular body having the opening 142 and a bottom 143 as a bottom surface, and defines the internal space 141 that is pillar-shaped. The container 140 has an inside diameter smaller than an outside diameter of the stick substrate 150 in at least a portion of the tubular body in the height direction, and may hold the stick substrate 150 while applying pressure around the stick substrate 150 inserted in the internal space 141. The container 140 also has a function for defining a flow path for air traveling through the stick substrate 150. An air inlet serving as an inlet for the air entering the flow path is disposed in, for example, the bottom 143. On the other hand, an air outlet serving as an outlet for the air exiting from the flow path is the opening 142.

The stick substrate 150 is a stick-shaped aerosol generating substrate. The stick substrate 150 includes a substrate 151 and an inhalation port 152.

The substrate 151 contains an aerosol source. The aerosol source atomizes by being heated, so that an aerosol is generated. The aerosol source may include, for example, a material derived from tobacco, such as a product obtained by forming shredded tobacco or tobacco raw material into a granular form, a sheet form, or a powder form. The aerosol source may also include a material not derived from tobacco and made from a plant (such as mint or herb) other than tobacco. If the inhaler device 100 is a medical inhaler, the aerosol source may include a medicine to be inhaled by a patient. The aerosol source is not limited to a solid and may be a liquid, such as polyhydric alcohol, including glycerine or propylene glycol, or water. At least a portion of the substrate 151 is accommodated in the internal space 141 of the container 140 in the state where the stick substrate 150 is held by the container 140.

The inhalation port 152 is a member to be held in the user's mouth during inhalation. At least a portion of the inhalation port 152 protrudes from the opening 142 in the state where the stick substrate 150 is held by the container 140. When the user holds the inhalation port 152 protruding from the opening 142 in the user's mouth and inhales, air flows into the container 140 through the air inlet (not illustrated). The air flowing in travels through the internal space 141 of the container 140, that is, through the substrate 151, and reaches the inside of the user's mouth together with the aerosol generated from the substrate 151.

The heater 121 heats the aerosol source so as to atomize the aerosol source and generate the aerosol. As will be described in detail later, the heater 121 is blade-shaped and is disposed to protrude from the bottom 143 of the container 140 to the internal space 141 of the container 140. Therefore, when the stick substrate 150 is inserted into the container 140, the blade-shaped heater 121 is inserted into the stick substrate 150 to pierce the substrate 151 of the stick substrate 150. When the heater 121 produces heat, the aerosol source contained in the stick substrate 150 atomizes by being heated from inside the stick substrate 150, whereby the aerosol is generated. The heater 121 produces heat when supplied with electric power from the power supply 111. In an example, when the sensor 112 detects that a predetermined user input has been performed, the heater 121 supplied with the electric power produces heat. When the temperature of the stick substrate 150 reaches the predetermined temperature, the aerosol is generated from the stick substrate 150. Accordingly, the inhaler device 100 allows for inhalation by the user. Subsequently, when the sensor 112 detects that a predetermined user input has been performed, the supply of electric power to the heater 121 may be stopped. In another example, in a time period in which the sensor 112 detects that the inhalation has been performed by the user, the aerosol may be generated by the heater 121 supplied with the electric power.

### 2. Detailed Configuration of Heater

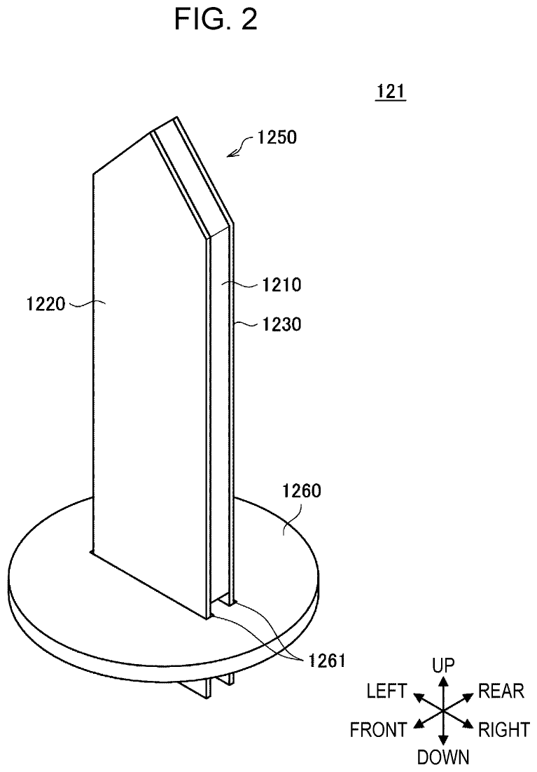

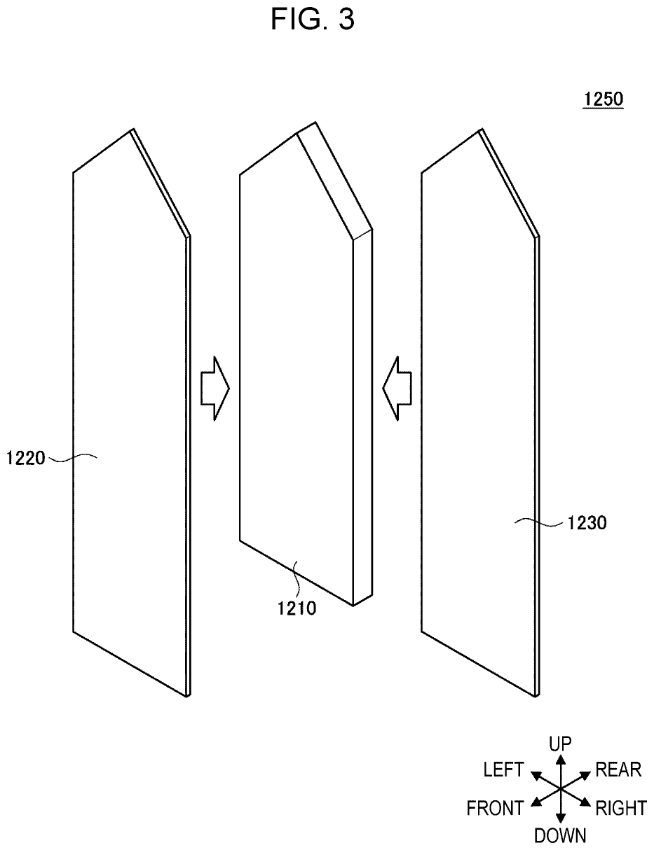

Next, the heater 121 included in the inhaler device 100 according to this embodiment will be described in further detail with reference to FIG. 2 and FIG. 3. FIG. 2 is a perspective view of the heater 121 according to this embodiment. FIG. 3 is an exploded perspective view of a heater body 1250 included in the heater 121 illustrated in FIG. 2.

As illustrated in FIG. 2, the heater 121 includes the heater body 1250 and a securing section 1260. The heater body 1250 is held at the securing section 1260 and is secured to, for example, a housing of the inhaler device 100 with the securing section 1260 interposed therebetween.

As illustrated in FIG. 3, the heater body 1250 includes a resistive heat generator 1210, a first electric conductor 1220, and a second electric conductor 1230. The heater body 1250 can heat the stick substrate 150 from the inside thereof by using heat generated from the resistive heat generator 1210 supplied with electricity via the first electric conductor 1220 and the second electric conductor 1230.

In FIG. 2 and FIG. 3, a direction in which the leading end of the heater body 1250 is inserted into the stick substrate 150 may also be referred to as “up direction”, and a direction opposite the up direction may also be referred to as “down direction”. A direction in which the first electric conductor 1220, the resistive heat generator 1210, and the second electric conductor 1230 are bonded together may also be referred to as “front-rear direction”, and a direction orthogonal to the up-down direction and the front-rear direction may also be referred to as “left-right direction”.

The resistive heat generator 1210 is a tabular member that generates heat by resistance heating. In detail, the resistive heat generator 1210 may be a PTC (positive temperature coefficient) heater that generates heat when electricity is supplied between the first electric conductor 1220 and the second electric conductor 1230.

A PTC heater uses a resistor having properties (PTC properties) in which an electrical resistance value increases significantly when the temperature reaches a predetermined temperature (referred to as “Curie temperature”) such that an electric current does not flow therethrough. By utilizing the PTC properties, a PTC heater can control the amount of supplied electricity without having to use a control device, so as to be capable of controlling the heating temperature below the Curie temperature. Therefore, a PTC heater can heat a target below the Curie temperature. For example, the resistive heat generator 1210 may be a PTC heater with barium titanate (BaTiO₃) having the PTC properties as the resistor. In such a case, the resistive heat generator 1210 can set the Curie temperature of the barium titanate to 350° C., so as to be capable of heating the stick substrate 150 to a temperature below 350° C.

Each property, such as the Curie temperature of the barium titanate having the PTC properties or the electrical resistance value, can be controlled by using, for example, an additive added in a very small quantity to the barium titanate. In detail, for example, an alkaline-earth metal element, such as calcium (Ca) or strontium (Sr), or a rare-earth metal element, such as yttrium (Y), neodymium (Nd), samarium (Sm), or dysprosium (Dy), may be added to the barium titanate. The added element replaces the Ba site or the Ti site of the barium titanate, so that the structure of the sintered body of the barium titanate can be controlled. With the structure of the sintered body being controlled, each property, such as the Curie temperature or the electrical resistance value, of the barium titanate can be controlled.

In the inhaler device 100 according to this embodiment, the resistive heat generator 1210 at least partially has a porous structure. By at least partially having a porous structure, the resistive heat generator 1210 can have reduced mass relative to the same volume, so that the thermal capacity can be reduced. Accordingly, the resistive heat generator 1210 can efficiently increase the temperature with a smaller amount of generated heat, so that the rate of temperature increase of the heater 121 can be further enhanced. A porous structure has a large number of pores. For example, in a porous structure, a porosity obtained by dividing the sum of the volume of the pores by the total volume is 10% or higher. The size of each of the pores formed in the porous structure is not particularly limited.

The resistive heat generator 1210 having such a porous structure can be manufactured by, for example, controlling the mixing condition, the dispersion condition, and the sintering condition of the titanium source and the barium source in the sintered body of the barium titanate.

Furthermore, the resistive heat generator 1210 having the porous structure can be manufactured by adding carbon and sintering the barium titanate. In such a case, the porosity of the porous structure that the resistive heat generator 1210 has can be controlled by the amount of carbon added.

For example, if the barium titanate is sintered to have a porous structure without adding carbon thereto, the porosity of the porous structure can be controlled to about 10%. If the mass ratio between barium titanate and carbon is controlled to 90:10 and the barium titanate is sintered to have a porous structure, the porosity of the porous structure can be controlled to about 50%. Furthermore, if the mass ratio between barium titanate and carbon is controlled between 75:25 and 10:90 and the barium titanate is sintered to have a porous structure, the porosity of the porous structure can be controlled to about 75%.

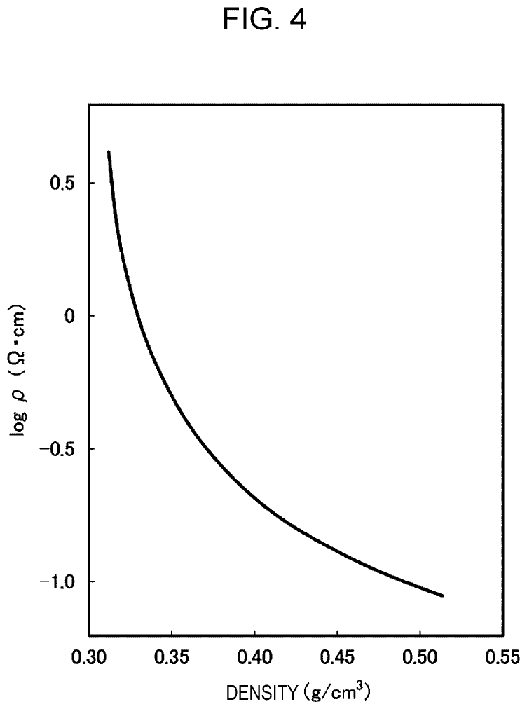

Furthermore, by controlling the amount of carbon added, the electrical resistance value of the resistive heat generator 1210 can also be controlled. However, when the density of carbon added to the barium titanate is 0.3 g/cm³ or more, the PTC properties of the barium titanate may possibly deteriorate. The aforementioned threshold value for the density of carbon will now be described with reference to FIG. 4. FIG. 4 is a graph schematically illustrating the relationship between the density of a carbon porous body and the electrical resistance value.

As illustrated in FIG. 4, the carbon porous body rapidly decreases in electrical resistance value when the density of carbon becomes 0.3 g/cm³ or more. This is because a carbon network forms more readily due to an increase in density, thus causing electric current to flow readily therethrough. Therefore, when the density of carbon added to the barium titanate becomes 0.3 g/cm³ or more, the electrical resistance value of the carbon becomes lower than the electrical resistance value of the barium titanate, possibly causing the electric current to flow only to the carbon. In such a case, the electric current does not flow to the barium titanate having the PTC properties, possibly causing the resistive heat generator 1210 to not function as a PTC heater. Therefore, the density of carbon added to the barium titanate is preferably controlled to be less than 0.3 g/cm³.

The density of the barium titanate is 6 g/cm³ in a state where the porosity is 10% when carbon is not added. Therefore, assuming that the density of the barium titanate is 3 g/cm³ in a state where the porosity is 50%, the resistive heat generator 1210 having a porous structure with a porosity of 50% includes 3 g/cm³ of barium titanate and less than 0.3 g/cm³ of carbon. Assuming that the density of the barium titanate is 1.5 g/cm³ in a state where the porosity is 75%, the resistive heat generator 1210 having a porous structure with a porosity of 75% includes 1.5 g/cm³ of barium titanate and less than 0.3 g/cm³ of carbon.

The porous structure of the resistive heat generator 1210 may include a plurality of regions with different porosities from each other.

In an example, the resistive heat generator 1210 may include the plurality of regions with the different porosities from each other by connecting a plurality of PTC heaters, having porous structures with different porosities from each other, in the longitudinal direction (i.e., the up-down direction). For example, the resistive heat generator 1210 may be provided with a region with a higher porosity at the leading end to be inserted into the stick substrate 150, and a region with a lower porosity at the trailing end. In such a case, the resistive heat generator 1210 can have a reduced thermal capacity in the region at the leading end to be inserted into the stick substrate 150, so that the rate of temperature increase at the leading end can be enhanced, whereby the stick substrate 150 can be heated more efficiently.

In another example, the resistive heat generator 1210 may include the plurality of regions with the different porosities from each other by connecting a plurality of PTC heaters, having porous structures with different porosities from each other, in the lateral direction (i.e., the left-right direction). In such a case, the resistive heat generator 1210 may be provided with a region with a higher porosity at a central portion of the resistive heat generator 1210, and regions with a lower porosity at the opposite ends. In such a case, the resistive heat generator 1210 can have a reduced thermal capacity in the region near the center of the stick substrate 150, so that the rate of temperature increase at the central portion can be enhanced, whereby the stick substrate 150 can be heated more efficiently.

The resistive heat generator 1210 may have a long tabular shape extending in the up-down direction. Specifically, the longitudinal direction of the long shape of the resistive heat generator 1210 corresponds to the up-down direction, whereas the lateral direction of the long shape corresponds to the left-right direction. By having a long tabular shape, the resistive heat generator 1210 has a rectangular cross-sectional shape that is orthogonal to the longitudinal direction (i.e., the up-down direction) of the long shape. Accordingly, as compared with a case where the resistive heat generator 1210 has a circular cross-sectional shape with the same surface area, the cross-sectional shape can have a longer perimeter. Therefore, the resistive heat generator 1210 can allow for a larger contact area between the heater 121 and the stick substrate 150 to which the heater 121 is to be inserted, whereby the stick substrate 150 can be heated more efficiently. For example, the tabular shape of the resistive heat generator 1210 may have a thickness smaller than ¼ of the width of the long shape in the lateral direction (i.e., the left-right direction).

The resistive heat generator 1210 at the leading end to be inserted into the stick substrate 150 may have an angularly protruding shape toward the leading end (i.e., in the up direction). The angular shape extending toward the leading end may have an acute angle, a right angle, or an obtuse angle. For example, the resistive heat generator 1210 may have a pentagonal tabular shape whose apex exists at the leading end (i.e., the upper end) to be inserted into the stick substrate 150 and that extends in the up-down direction. With regard to the resistive heat generator 1210, the leading end (i.e., the upper end) thereof to be inserted into the stick substrate 150 has a pointy shape like a sword tip, so that the heater 121 can be inserted into the stick substrate 150 more readily.

The first electric conductor 1220 and the second electric conductor 1230 are a pair of electrode plates sandwiching the resistive heat generator 1210 therebetween. In detail, the first electric conductor 1220 and the second electric conductor 1230 may be provided at opposite principal surfaces opposing each other in the front-rear direction of the tabular resistive heat generator 1210. The first electric conductor 1220 and the second electric conductor 1230 are provided apart from each other to prevent a short-circuit.

The first electric conductor 1220 and the second electric conductor 1230 are bonded to the resistive heat generator 1210 by using a conductive adhesive paste, so that electricity can be supplied to the resistive heat generator 1210. An example of the conductive adhesive paste that can be used is a so-called anisotropic conductive adhesive having conductive particles uniformly distributed within an epoxy-based adhesive.

In an example, the first electric conductor 1220 and the second electric conductor 1230 may be composed of metal with a low thermal expansion coefficient. For example, the first electric conductor 1220 and the second electric conductor 1230 may be composed of a nickel (Ni) containing iron alloy with a low thermal expansion coefficient, such as Invar (registered trademark). Accordingly, delamination of the first electric conductor 1220 and the second electric conductor 1230 from the resistive heat generator 1210 due to thermal expansion occurring when the resistive heat generator 1210 generates heat can be suppressed.

In another example, the first electric conductor 1220 and the second electric conductor 1230 may each be formed of a carbon sheet having electrical conductivity. The first electric conductor 1220 and the second electric conductor 1230 formed of carbon sheets undergo little dimensional change at high temperature, so that delamination from the resistive heat generator 1210 due to thermal expansion occurring when the resistive heat generator 1210 generates heat can be suppressed. Furthermore, since carbon sheets are lightweight, the first electric conductor 1220 and the second electric conductor 1230 contribute to further weight reduction of the heater 121, thereby further enhancing the portability of the inhaler device 100 including the heater 121.

In another example, the first electric conductor 1220 and the second electric conductor 1230 may each be formed of a laminated body of metal and a carbon sheet. For example, the first electric conductor 1220 and the second electric conductor 1230 may be each formed of a laminated body of Invar (registered trademark) and a carbon sheet. In each of the first electric conductor 1220 and the second electric conductor 1230, the carbon sheet is laminated to face the resistive heat generator 1210, so that delamination caused due to a difference in thermal expansion coefficient from the resistive heat generator 1210 can be further suppressed.

The first electric conductor 1220 and the second electric conductor 1230 may be provided to cover the resistive heat generator 1210 by having a shape that conforms with the shape of the resistive heat generator 1210. In detail, the first electric conductor 1220 and the second electric conductor 1230 may each have a shape that extends further in the longitudinal direction (i.e., the up-down direction) relative to the long shape of the resistive heat generator 1210. For example, the first electric conductor 1220 and the second electric conductor 1230 may each be similar to the resistive heat generator 1210 in having a pentagonal tabular shape whose apex exists at the leading end (i.e., the upper end) to be inserted into the stick substrate 150 and that extends in the up-down direction. The first electric conductor 1220 and the second electric conductor 1230 may have the same shape or may have shapes different from each other.

The trailing end (i.e., the lower end) opposite the leading end of each of the first electric conductor 1220 and the second electric conductor 1230 may extend further downward relative to the trailing end of the resistive heat generator 1210. For example, downward-extending regions of the first electric conductor 1220 and the second electric conductor 1230 are inserted into the securing section 1260, whereby the heater body 1250 is secured to the housing of the inhaler device 100.

The securing section 1260 is a structural member that secures the heater body 1250 to the housing of the inhaler device 100. In detail, the securing section 1260 has a circular or rectangular tabular shape having an insertion section 1261 with a slit-like recess structure or through-hole structure.

The insertion section 1261 may be two recesses or through-holes into which the first electric conductor 1220 and the second electric conductor 1230 are to be respectively inserted, or may be one recess or through-hole into which the first electric conductor 1220 and the second electric conductor 1230 are to be collectively inserted. With the first electric conductor 1220 and the second electric conductor 1230 being inserted into the insertion section 1261, the securing section 1260 can hold the heater body 1250 and can secure the heater body 1250 to the housing of the inhaler device 100.

The securing section 1260 may be composed of a super engineering plastic material. A super engineering plastic material has high heat resistance and high mechanical strength and can be formed into a desired shape inexpensively by injection molding, and is therefore suitable for use as a material for forming a structural member. For example, the securing section 1260 may be composed of PEEK (polyether ether ketone), which is a type of engineering plastic material. PEEK is thermoplastic resin having extremely high heat resistance and also having high dimensional stability. Therefore, when the securing section 1260 is composed of PEEK, a dimensional change in the securing section 1260 caused by the heat generated by the resistive heat generator 1210 is further reduced.

The securing section 1260 may hold the first electric conductor 1220 and the second electric conductor 1230 at the regions of the first electric conductor 1220 and the second electric conductor 1230 extending further downward relative to the trailing end of the resistive heat generator 1210. By holding the heater body 1250 at the regions located away from the resistive heat generator 1210, the securing section 1260 can reduce the possibility of transmission of the heat generated from the resistive heat generator 1210. In such a case, with regard to the securing section 1260, the material thereof can be selected more flexibly in view of not only heat resistance but also machinability and cost. For example, the material that can be used for forming the securing section 1260 may be resin with a melting point or glass transition point lower than that of, for example, metal. Furthermore, since the securing section 1260 is not directly in contact with the resistive heat generator 1210, the securing section 1260 can further reduce the possibility of transmission of the heat generated from the resistive heat generator 1210 to the housing of the inhaler device 100.

In the above configuration, the heater 121 according to this embodiment can have a reduced thermal capacity due to the resistive heat generator 1210 at least partially having the porous structure, so that the temperature can be increased with a smaller amount of generated heat. Consequently, the inhaler device 100 according to this embodiment can further enhance the rate of temperature increase of the heater 121.

### 3. Modifications

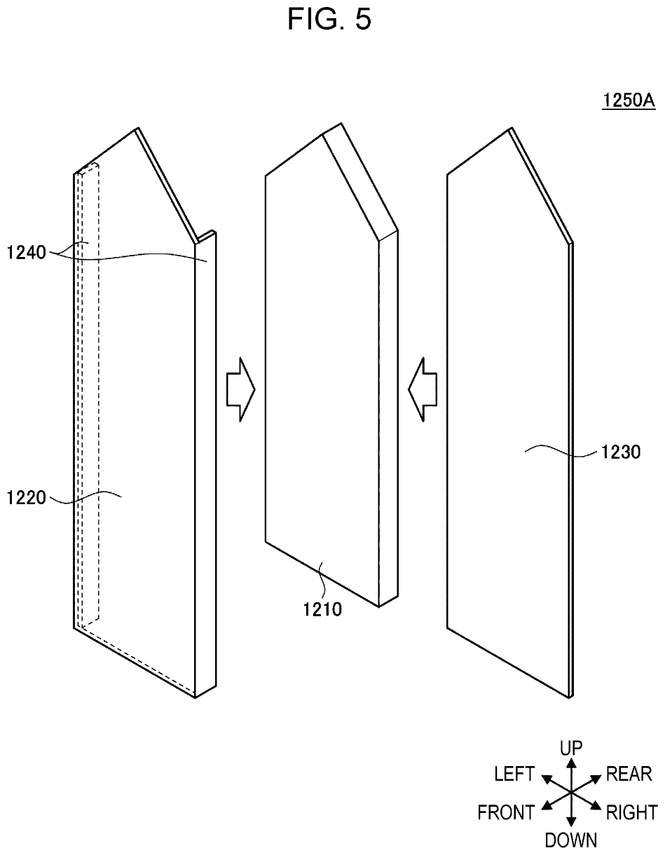

First to third modifications of the heater body 1250 according to this embodiment will now be described with reference to FIG. 5 to FIG. 7. Since the first electric conductor 1220 and the second electric conductor 1230 are interchangeable, a description about the first electric conductor 1220 can be interchangeably interpreted as a description about the second electric conductor 1230.

### First Modification

FIG. 5 is an exploded perspective view of a heater body 1250A according to a first modification. In FIG. 5, the up-down direction, the front-rear direction, and the left-right direction are defined similarly to FIG. 2 and FIG. 3. In detail, a direction in which the leading end of the heater body 1250A is inserted into the stick substrate 150 may also be referred to as “up direction”, and a direction opposite the up direction may also be referred to as “down direction”. A direction in which the first electric conductor 1220, the resistive heat generator 1210, and the second electric conductor 1230 are bonded together may also be referred to as “front-rear direction”, and a direction orthogonal to the up-down direction and the front-rear direction may also be referred to as “left-right direction”.

As illustrated in FIG. 5, in the heater body 1250A according to the first modification, at least one of the first electric conductor 1220 and the second electric conductor 1230 is further provided with ribs 1240.

In detail, the ribs 1240 are formed by bending opposite edges, in the lateral direction (i.e., the left-right direction) of the long shape of the first electric conductor 1220, along the outer shape of the resistive heat generator 1210. For example, if the first electric conductor 1220 has a pentagonal shape extending in the up-down direction, the ribs 1240 may be formed by bending the opposite left and right edges extending from the first electric conductor 1220.

With the ribs 1240 provided, the first electric conductor 1220 has increased strength in the front-rear direction in which the ribs 1240 are bent, so that deformation in the front-rear direction can be suppressed. Accordingly, the heater body 1250A is less likely to deform in the normal direction (i.e., the front-rear direction) to the principal surfaces of the first electric conductor 1220, so that the possibility of breakage of the heater body 1250A in the normal direction can be reduced. With the heater body 1250A according to the first modification, the heater 121 can have increased strength in the front-rear direction, so that the possibility of breakage of the heater 121 when inserted into the stick substrate 150 can be reduced.

### Second Modification

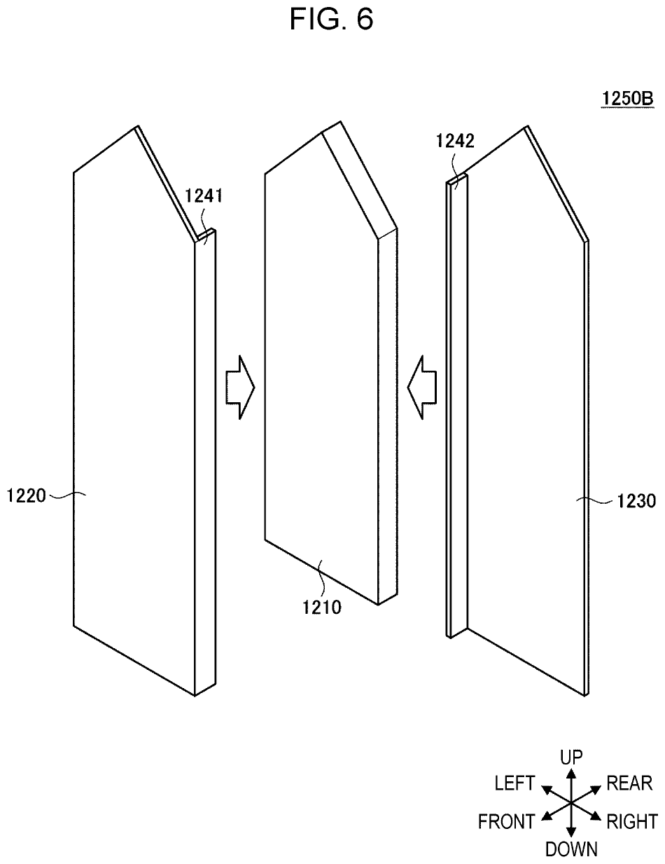

FIG. 6 is an exploded perspective view of a heater body 1250B according to a second modification. In FIG. 6, the up-down direction, the front-rear direction, and the left-right direction are defined similarly to FIG. 2 and FIG. 3. In detail, a direction in which the leading end of the heater body 1250B is inserted into the stick substrate 150 may also be referred to as “up direction”, and a direction opposite the up direction may also be referred to as “down direction”. A direction in which the first electric conductor 1220, the resistive heat generator 1210, and the second electric conductor 1230 are bonded together may also be referred to as “front-rear direction”, and a direction orthogonal to the up-down direction and the front-rear direction may also be referred to as “left-right direction”.

As illustrated in FIG. 6, in the heater body 1250B according to the second modification, the first electric conductor 1220 is provided with a first rib 1241, and the second electric conductor 1230 is provided with a second rib 1242.

In detail, the first rib 1241 is formed by bending one of the edges, in the lateral direction (i.e., the left-right direction) of the long shape of the first electric conductor 1220, along the outer shape of the resistive heat generator 1210. The second rib 1242 is formed by bending the other one of the edges, in the lateral direction (i.e., the left-right direction) of the long shape of the second electric conductor 1230, along the outer shape of the resistive heat generator 1210. For example, if the first electric conductor 1220 and the second electric conductor 1230 have a pentagonal shape extending in the up-down direction, the first rib 1241 maybe formed by bending the right edge extending from the first electric conductor 1220. Moreover, the second rib 1242 may be formed by bending the left edge extending from the second electric conductor 1230.

With the first rib 1241 and the second rib 1242 provided, the first electric conductor 1220 and the second electric conductor 1230 have increased strength in the front-rear direction in which the first rib 1241 and the second rib 1242 are bent, so that deformation in the front-rear direction can be suppressed. Accordingly, the heater body 1250B is less likely to deform in the normal direction (i.e., the front-rear direction) to the principal surfaces of the first electric conductor 1220 and the second electric conductor 1230, so that the possibility of breakage of the heater 121 in the normal direction can be reduced.

Specifically, the first rib 1241 and the second rib 1242 maybe provided at both of the pair of electrode plates (i.e., the first electric conductor 1220 and the second electric conductor 1230). In such a case, the heater body 1250B according to the second modification is similar to the heater body 1250A according to the first modification in that the possibility of breakage of the heater 121 when inserted into the stick substrate 150 can be reduced.

### Third Modification

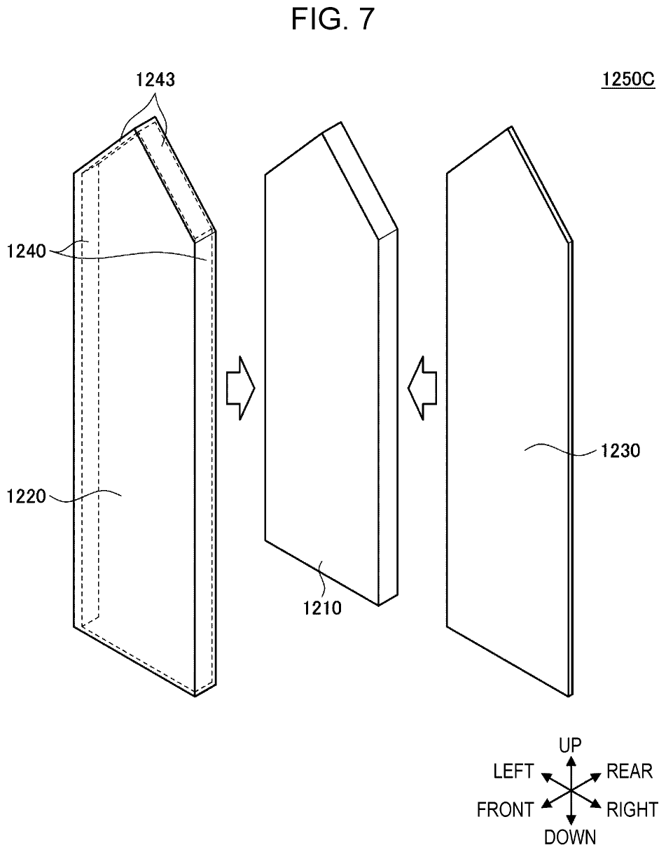

FIG. 7 is an exploded perspective view of a heater body 1250C according to a third modification. In FIG. 7, the up-down direction, the front-rear direction, and the left-right direction are defined similarly to FIG. 2 and FIG. 3. In detail, a direction in which the leading end of the heater body 1250C is inserted into the stick substrate 150 may also be referred to as “up direction”, and a direction opposite the up direction may also be referred to as “down direction”. A direction in which the first electric conductor 1220, the resistive heat generator 1210, and the second electric conductor 1230 are bonded together may also be referred to as “front-rear direction”, and a direction orthogonal to the up-down direction and the front-rear direction may also be referred to as “left-right direction”.

As illustrated in FIG. 7, in addition to the ribs 1240, the heater body 1250C according to the third modification is further provided with leading-end ribs 1243 in conformity with the angularly protruding shape toward the leading end (i.e., in the up direction) of the resistive heat generator 1210.

In detail, the leading-end ribs 1243 are formed by bending upper edges (located toward the leading end of the resistive heat generator 1210) of the first electric conductor 1220 along the outer shape of the resistive heat generator 1210. For example, if the first electric conductor 1220 has a pentagonal shape extending in the up-down direction, the leading-end ribs 1243 may be formed by bending two upper edges of the first electric conductor 1220. In such a case, the first electric conductor 1220 has the ribs 1240 or the leading-end ribs 1243 at four edges excluding the lower edge of the pentagonal shape.

With the leading-end ribs 1243 provided, the first electric conductor 1220 can cover the sword-tip-like pointy-shaped leading end (i.e., the upper end) of the resistive heat generator 1210 with the leading-end ribs 1243. Accordingly, when the heater 121 is inserted into the stick substrate 150, the heater body 1250C can prevent delamination of the first electric conductor 1220 and the second electric conductor 1230 from the resistive heat generator 1210 due to a force acting among the resistive heat generator 1210, the first electric conductor 1220, and the second electric conductor 1230. Therefore, the heater body 1250C can further improve the durability of the heater 121 against insertion thereof into the stick substrate 150.

Although a preferred embodiment of the present invention has been described in detail above with reference to the appended drawings, the present invention is not limited to this example. It is apparent to a person with a common knowledge of the technical field to which the present invention belongs that various modifications and alterations are conceivable within the scope of the technical ideas defined in the claims, and it is to be understood that such modifications and alterations naturally belong to the technical scope of the present invention.

The following configurations also belong to the technical scope of the present invention.

(1) An aerosol generation system comprising:
a resistive heat generator at least partially having a porous structure and heating an aerosol generating substrate from an inside thereof; and
a pair of tabular electric conductors provided at opposite surfaces of the resistive heat generator.

(2) The aerosol generation system according to (1), wherein the porous structure includes a plurality of regions with different porosities from each other.

(3) The aerosol generation system according to (1) or (2), wherein the resistive heat generator contains barium titanate.

(4) The aerosol generation system according to (3), wherein the resistive heat generator further contains less than 0.3 g/cm³ of carbon.

(5) The aerosol generation system according to any one of (1) to (4), further comprising a securing section having an insertion section into which the electric conductors are inserted, the securing section securing the electric conductors to a housing.

(6) The aerosol generation system according to (5), wherein the securing section is composed of a super engineering plastic material.

(7) The aerosol generation system according to (5) or (6), wherein the securing section has a circular or rectangular tabular shape.

(8) The aerosol generation system according to any one of (1) to (7), wherein each of the electric conductors is composed of metal or carbon.

(9) The aerosol generation system according to (8), wherein each of the electric conductors is composed of a nickel-containing iron alloy.

(10) The aerosol generation system according to any one of (1) to (9), wherein the resistive heat generator has a tabular shape.

(11) The aerosol generation system according to (10), wherein a thickness of the tabular shape is smaller than ¼ of a width of the tabular shape.

(12) The aerosol generation system according to any one of (1) to (11), further comprising the aerosol generating substrate into which the resistive heat generator and the electric conductors are inserted.

(13) The aerosol generation system according to any one of (1) to (12), wherein at least one of the electric conductors includes a rib formed by bending an edge of the electric conductor along an outer shape of the resistive heat generator from the opposite surfaces of the resistive heat generator.

(14) The aerosol generation system according to any one of (1) to (13), wherein the resistive heat generator has an angularly protruding shape toward a leading end to be inserted into the aerosol generating substrate.

(15) The aerosol generation system according to (14), wherein at least one of the electric conductors further includes a leading-end rib formed by bending an edge of the electric conductor along the shape at the leading end of the resistive heat generator.

(16) The aerosol generation system according to any one of (1) to (15), wherein the resistive heat generator and the electric conductors are adhered together by using a conductive adhesive paste.

(17) The aerosol generation system according to any one of (1) to (16), wherein the resistive heat generator is a PTC heater.

(18) The aerosol generation system according to any one of (1) to (17), wherein a temperature of heat generated by the resistive heat generator is below 350° C.

### Reference Signs List

100 inhaler device
121 heater
140 container
141 internal space
142 opening
143 bottom
150 stick substrate
151 substrate
152 inhalation port
1210 resistive heat generator
1220 first electric conductor
1230 second electric conductor
1240 rib
1241 first rib
1242 second rib
1243 leading-end rib
1250 heater body
1260 securing section
1261 insertion section

1. An aerosol generation system comprising:
a resistive heat generator at least partially having a porous structure and heating an aerosol generating substrate from an inside thereof; and
a pair of tabular electric conductors provided at opposite surfaces of the resistive heat generator.

2. The aerosol generation system according to claim 1, wherein the porous structure includes a plurality of regions with different porosities from each other.

3. The aerosol generation system according to claim 1, wherein the resistive heat generator contains barium titanate.

4. The aerosol generation system according to claim 3, wherein the resistive heat generator further contains less than 0.3 g/cm³ of carbon.

5. The aerosol generation system according to claim 1, further comprising a securing section having an insertion section into which the electric conductors are inserted, the securing section securing the electric conductors to a housing.

6. The aerosol generation system according to claim 5, wherein the securing section is composed of a super engineering plastic material.

7. The aerosol generation system according to claim 5, wherein the securing section has a circular or rectangular tabular shape.

8. The aerosol generation system according to claim 1, wherein each of the electric conductors is composed of metal or carbon.

9. The aerosol generation system according to claim 8, wherein each of the electric conductors is composed of a nickel-containing iron alloy.

10. The aerosol generation system according to claim 1, wherein the resistive heat generator has a tabular shape.

11. The aerosol generation system according to claim 10, wherein a thickness of the tabular shape is smaller than ¼ of a width of the tabular shape.

12. The aerosol generation system according to claim 1, further comprising the aerosol generating substrate into which the resistive heat generator and the electric conductors are inserted.

13. The aerosol generation system according to claim 1, wherein at least one of the electric conductors includes a rib formed by bending an edge of the electric conductor along an outer shape of the resistive heat generator from the opposite surfaces of the resistive heat generator.

14. The aerosol generation system according to claim 1, wherein the resistive heat generator has an angularly protruding shape toward a leading end to be inserted into the aerosol generating substrate.

15. The aerosol generation system according to claim 14, wherein at least one of the electric conductors further includes a leading-end rib formed by bending an edge of the electric conductor along the shape at the leading end of the resistive heat generator.

16. The aerosol generation system according to claim 1, wherein the resistive heat generator and the electric conductors are adhered together by using a conductive adhesive paste.

17. The aerosol generation system according to claim 1, wherein the resistive heat generator is a PTC heater.

18. The aerosol generation system according to claim 1, wherein a temperature of heat generated by the resistive heat generator is below 350° C.
